(19) United States
(12) Patent Application Publication
(10) Pub. No.: US 2026/0044933 A1
(43) Pub. Date: Feb. 12, 2026

(54) METHOD, APPARATUS, AND MEDIUM FOR POINT CLOUD PROCESSING

(71) Applicants: Douyin Vision Co., Ltd., Beijing (CN); Bytedance Inc., Los Angeles, CA (US)

(72) Inventors: Xiaoqi MA, Beijing (CN); Yichen ZHOU, Beijing (CN); Yingzhan XU, Beijing (CN); Kai ZHANG, Los Angeles, CA (US); Li ZHANG, Los Angeles, CA (US); Xinfeng ZHANG, Beijing (CN)

(21) Appl. No.: 19/362,098

(22) Filed: Oct. 17, 2025

Related U.S. Application Data
(63) Continuation of application No. PCT/CN2024/088674, filed on Apr. 18, 2024.

(30) Foreign Application Priority Data
Apr. 19, 2023 (WO) PCT/CN2023/089354

(51) Int. Cl. G06T 3/4053; G06T 3/4046

(52) U.S. Cl. CPC G06T 3/4053; G06T 3/4046

(57) ABSTRACT

Embodiments of the present disclosure provide a solution for point cloud processing. A method for point cloud processing is proposed. The method comprises: upsampling first geometry information of a first point cloud (PC) sample; upsampling first attribute information of the first PC sample; and determining second geometry information and second attribute information of a second PC sample based on the upsampled first geometry information and the upsampled first attribute information, wherein the second PC sample corresponds to the first PC sample, and a resolution of the second PC sample is higher than a resolution of the first PC sample.

### CROSS REFERENCE TO RELATED APPLICATIONS

This application is a continuation of International Application No. PCT/CN2024/088674, filed on Apr. 18, 2024, which claims the benefit of International Application No. PCT/CN2023/089354, filed on Apr. 19, 2023. The entire contents of these applications are hereby incorporated by reference in their entireties.

### FIELDS

Embodiments of the present disclosure relates generally to point cloud processing techniques, and more particularly, to point cloud super-resolution.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Due to the increased popularity of augmented and virtual reality experiences, the interest in capturing high resolution real-world point clouds has never been higher. Loss of details and irregularities in point cloud geometry and attribute can occur during the capturing, processing, and compression pipeline. It is essential to address these challenges by being able to upsample a low Level-of-Detail (LoD) point cloud into a high LoD point cloud. Current upsampling methods suffer from several weaknesses in handling point cloud upsampling. Thus, performance of conventional point cloud super-resolution techniques is generally expected to be further improved.

### SUMMARY

Embodiments of the present disclosure provide a solution for point cloud processing.

In a first aspect, a method for point cloud processing is proposed. The method comprises: upsampling first geometry information of a first point cloud (PC) sample; upsampling first attribute information of the first PC sample; and determining second geometry information and second attribute information of a second PC sample based on the upsampled first geometry information and the upsampled first attribute information, wherein the second PC sample corresponds to the first PC sample, and a resolution of the second PC sample is higher than a resolution of the first PC sample.

Based on the method in accordance with the first aspect of the present disclosure, both the geometry information and the attribute information of a point cloud are upsampled. Compared with the conventional solution where only one of the geometry information and the attribute information is upsampled, the proposed method can advantageously support joint super-resolution of geometry information and attribute information of the point cloud. Thereby, the performance of point cloud super-resolution can be improved.

In a second aspect, an apparatus for point cloud processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder, in accordance with some embodiments of the present disclosure;

FIG. 3 illustrates a block diagram that illustrates an example point cloud decoder, in accordance with some embodiments of the present disclosure;

FIG. 4 illustrates an example flow chart of the joint super-resolution of point cloud geometry and attribute in accordance with embodiments of the present disclosure;

FIG. 5 illustrates a flowchart of a method for point cloud processing in accordance with embodiments of the present disclosure; and

FIG. 6 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

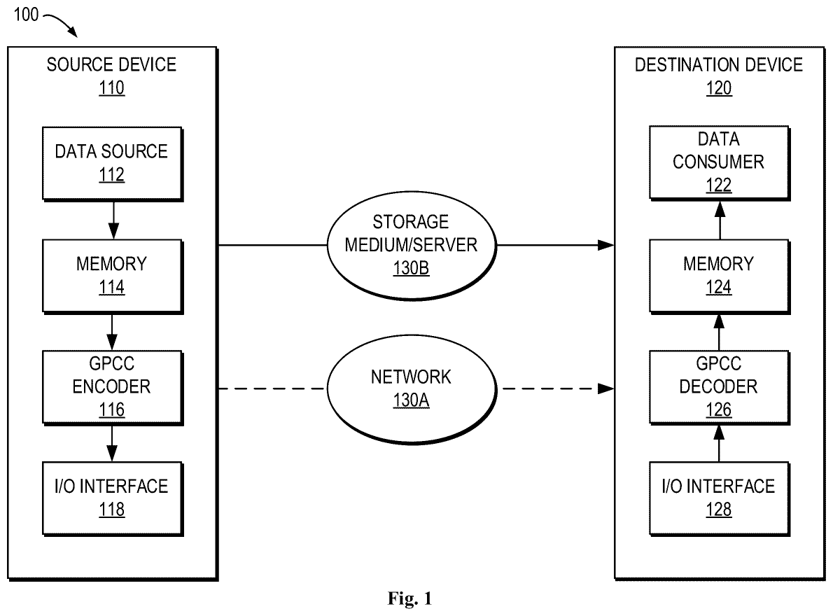

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like.

In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data.

For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like.

In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

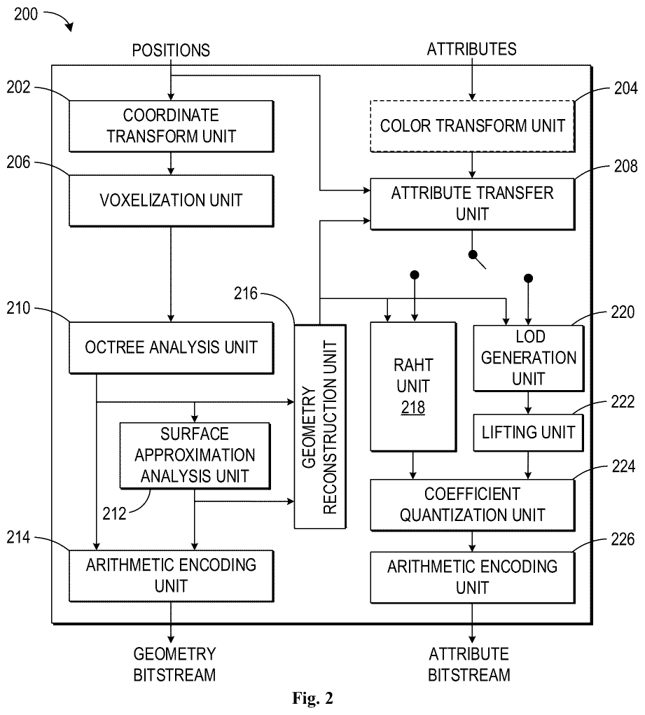

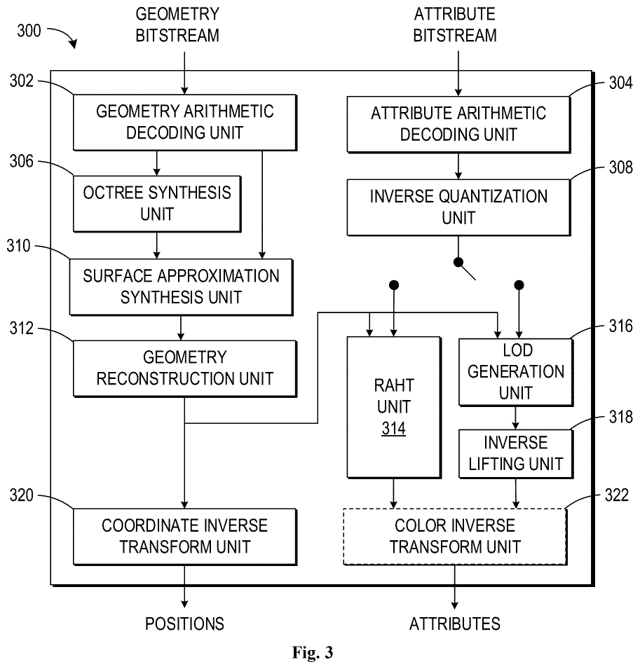

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable.

In some examples, one or more of the units may be distinct circuit blocks (fixed-function or programmable), and in some examples, one or more of the units may be integrated circuits.

Some exemplary embodiments of the present disclosure will be described in detailed hereinafter.

It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Brief Summary

This disclosure is related to point cloud processing technologies. Specifically, it is about point cloud joint super-resolution of point cloud geometry and attribute. The ideas may be applied as a post-processing individually or in various combination, to any point cloud coding standard or non-standard point cloud codec, e.g., the being-developed Artificial Intelligence based Point Cloud Compression (AI-PCC), Geometry based Point Cloud Compression (G-PCC) and Video based Point Cloud Compression (V-PCC).

### 2. Abbreviations

G-PCC Geometry based Point Cloud Compression
AI-PCC Artificial Intelligence based Point Cloud Compression
PCSR Point Cloud Super Resolution
PCGC Point Cloud Geometry Compression
KNN K Nearest Neighbors

### 3. Introduction

Due to the increased popularity of augmented and virtual reality experiences, the interest in capturing high resolution real-world point clouds has never been higher. Loss of details and irregularities in point cloud geometry and attribute can occur during the capturing, processing, and compression pipeline. It is essential to address these challenges by being able to upsample a low Level-of-Detail (LoD) point cloud into a high LoD point cloud. Current upsampling methods suffer from several weaknesses in handling point cloud upsampling. For example, it is hard to deal with dense real-world photo-realistic point clouds and most upsampling methods only support upsampling of point cloud geometry information and do not support upsampling of point cloud attribute information. This disclosure proposed a joint super-resolution of point cloud geometry and attribute method which can process a diverse set of point clouds including synthetic mesh-based point clouds, real-world high-resolution point clouds, real-world indoor LiDAR scanned objects, as well as outdoor dynamically acquired LiDAR-based point clouds.

### 3.1 Deep Learning in Point Cloud Network

Recent advances in deep learning have seen a lot of success in point cloud processing using deep learning models. The raw format of point cloud lacks point order and has an irregular structure which brings new challenges in employing deep learning solutions for point cloud processing. These methods can be roughly divided into two categories, voxel-based point cloud compression and point-based point cloud compression. For voxel-based methods, point clouds are voxelized into multiple blocks, which are processed by 3D convolution neural networks such as sparse convolution. For point-based methods, such as FoldingNet, directly process the original point clouds with graph-based convolution network and transformer-based network.

### 3.2 Deep Learning-Based Point Cloud Geometry Super-Resolution Methods

For point cloud geometry super-resolution methods, PU-Net was the pioneer deep learning upsampling work on point cloud that uses PointNet++ for feature extraction. PU-Net uses multi-branch MLPs to expand features with a joint reconstruction and repulsion loss to generate uniform point clouds. EC-Net intended to improve PU-Net work and introduced a point-to-edge distance loss, which can help preserve the edges. However, EC-Net requires the tedious work of labeling the point cloud data with annotated edge and surface information. An existing design proposed PU-GCN that uses a multi-level feature extraction using an inception-based graph convolutional network. They employ shuffling rather than duplicating features to expand the feature space for upsampling. However, these methods use kNN search-based patch selection for neighborhood feature aggregation. Raw points within the patch can be in any order and are processed directly by fully connected layers without considering the relative point location in the overall 3D representation or the point's distance from its neighbors. Furthermore, these methods are also memory hungry and computationally intensive, which is why they are limited to fixed small input sizes. Therefore, the current state-of-the-art in point cloud upsampling fails to build deeper architectures with large receptive fields that can effectively learn discriminative features and be able to efficiently work on denser point clouds that have a large number of points.

### 3.3 Deep Learning-Based Point Cloud Attribute Super-Resolution Methods

Although geometry super-resolution to densify a point cloud's geometry has been well explored, the super resolution of the point cloud attributes has been largely overlooked. CU-Net, the first deep-learning point cloud color upsampling model that enables low latency and high visual fidelity operation. CU-Net achieves linear time and space complexity by leveraging a feature extractor based on sparse convolution and a color prediction module based on neural implicit function. However, this method only focuses on the super-resolution of point cloud attribute information and does not consider the super-resolution of point cloud geometry information.

### 4. Problems

The existing designs for Point Cloud Super Resolution (PCSR) methods have the following problems:
1. The geometry and attribute information are both important for point cloud. However, the existing point cloud super resolution methods mainly focus on upsampling the geometry information of point clouds, lacking methods for upsampling point cloud attribute information. The joint super-resolution of point cloud geometry and attribute information is a new field that lacks exploration.
2. The point cloud geometry information mainly represents the spatial topology of the point cloud, different parts of the topology have different meanings, more specifically, each point in the point cloud is not equally important. However, the current methods do not take into account the different nature of each point when upsampling geometry information, and upsample the different topologies of the point cloud equally.
3. There is correlation between geometry and attribute information of point clouds, which can be used as effective supervisory information for joint constraint during point cloud upsampling. However, current upsampling methods lack the exploration and research on the mutual correlation between point cloud geometry and attribute information.
4. The current deep learning based point cloud super-resolution mainly focus on processing grid synthetic mesh-based point clouds. However, these point clouds are less commonly used in reality.
5. The purpose of point cloud super-resolution is to provide higher quality point clouds in downstream tasks, but existing methods generally do not explore support for downstream tasks, such as combining point cloud compression technology to improve encoding and decoding efficiency.

### 5. Detailed Solutions

To solve the above problems and some other problems not mentioned, methods as summarized below are disclosed. The solutions should be considered as examples to explain the general concepts and should not be interpreted in a narrow way. Furthermore, these solutions can be applied individually or combined in any manner.
1) It is proposed to build the initial geometry structure features of the low resolution point clouds.
   a. In one example, the geometry structure features may be generated by using convolution to expand the feature dimension only.
   b. In one example, the geometry structure features may be generated by applying complex variable-point expansion operations.
   c. In on example, the geometry structure features may be generated by using down-sampling, up-sampling symmetric structure of variable-point feature expansion operations.
      i. In one example, the down-sampling operation of geometry structure features generating may be implemented using sparse tensor based convolution network.
         1. In one example, multiple consecutive down-sampling operations may be used. For example, two consecutive down-sampling operations may be used.
      ii. In one example, the up-sampling operation may be implemented using lossless sparse deconvolution.
         1. In one example, multiple consecutive up-sampling operations may be used. For example, three consecutive up-sampling operations may be used.
   d. In one example, the geometry structure features may be generated by the combination of partial of the above methods.
   e. In one example, there may be at least one indication to indicate the way to generate the geometry structure.
      i. In one example, the indication may be pre-defined.
      ii. In one example, the indication may be signalled to the decoder.
      iii. In one example, the indication may be adaptive setting.
         1. In one example, the indication may be adaptively set based on the upsampling rate, etc. al.
2) It is proposed to get the high-resolution point clouds based on the one-stage or multi-stage up-sample results.
   a. In one example, the high-resolution point cloud may be obtained directly by up-sampling in one time.
   b. In one example, the high-resolution point cloud may be obtained directly by multiple progressive up-sampling.
      i. In one example, the point cloud may be reconstructed using N up-sampling operations, such as N=3.
      ii. In one example, there may be at least one indication to indicate N.
         1. In one example, the indication may be pre-defined.
         2. In one example, the indication may be signalled to the decoder.
         3. In one example, the indication may be adaptive setting.
         a. In one example, the indication may be adaptively set based on the upsampling rate, etc. al.
   c. In one example, the sparse-tensor based generative convolution may be used to perform point cloud up-sampling.
   d. In one example, a loss function may be used to constrain upsampling network during the training process of the point cloud super resolution.
      i. In one example, the multi-stage progressive loss function may be used.
      ii. In one example, the one-stage loss function may be used.
      iii. In one example, the Binary Cross Entropy (BCE) value may be used as the loss function in every stage.

$${L}_{BCE} = 1 / N * {\sum }_{i} - ( {x}_{i} log ( {p}_{i} ) + ( 1 - {x}_{i} ) log ( 1 - {p}_{i} ) )$$

iv. In one example, the points of the structure may be assigned different priorities.
   1. In one example, the priority of point may be determined by the importance of the point.
v. In one example, for each stage, the specific part of points may be used to constrain the upsampling.
vi. In one example, the points with higher priority may be used to constrain the upsampling in the early stage.
vii. In one example, the range of points to be used to constrain the upsample in each stage may be indicated by at least one indication.
   1. For example, there are 3 stages and 3 related indications, K/M/N.
   a. In one example, the top K % points of importance of the high-resolution point cloud may be used to constrain the upsampling point cloud in the first stage.
   b. In one example, the top M % points of importance of the high-resolution point cloud may be used to constrain the upsampling point cloud in the second stage.
   c. In one example, the top N % points of importance of the high-resolution point cloud may be used to constrain the upsampling point cloud in the last stage.
   d. In one example, K<M<N, such as K=30, M=60,N=100.
   2. In one example, the indication may be pre-defined.
   3. In one example, the indication may be signalled to the decoder.
   4. In one example, the indication may be adaptive setting.
   a. In one example, the indication may be adaptively set based on the upsampling rate, etc. al.
3) It is proposed to compute the attribute information of high-resolution point clouds based on the Recolouring algorithm.
   a. In one example, the attribute information of the high-resolution point cloud may be calculated based on the geometry upsampling result.
   b. In one example, the geometry information after upsampling may be used to guide the attribute information upsampling.
      i. In one example, the Euclidean distance may be used as the main calculation reference for geometry information guidance.
         1. In one example, the Euclidean distance may be used to calculate the nearest neighbours between high resolution point clouds and low resolution point clouds.
      ii. In one example, for the points in high resolution point clouds, the K Nearest Neighbors (KNN) algorithm may be used to obtain the local points in the low-resolution point cloud.
   c. In one example, the nearest neighbour algorithm may be used to calculate the attribute information of the point clouds after geometry upsampling.
      i. In one example, the distance-weighted algorithm may be used to calculate the attribute information of the points in high resolution point clouds from the local points in the low-resolution point cloud.
4) It is proposed to generate and learn the color residuals between the recolored point cloud and the original point cloud by a learning-based approach.
   a. In one example, a neural network approach may be used to learn the residuals between the recolored and original points.
      i. In one example, the neural network similar to the U-Net structural network may be used to learn the residuals of the attribute between the high resolution point cloud and the original point cloud.
         1. In one example, the residuals may be learned using a U-Net network based on sparse convolution operations.
      ii. In one example, the neural network similar to the MLP structural network may be used to learn the residuals of the attribute between the high resolution point cloud and the original point cloud.
         1. In one example, the MLP operation of attribute residuals generating may be implemented using sparse tensor based convolution network.
   b. In one example, the attribute residuals between the high resolution and original point clouds may be learned using supervised learning.
      i. In one example, the error between the constructed high resolution points and the true points may be used to update the neural network.
      ii. In one example, the L2 distance may be used as the loss function for residual learning.
         1. In one example, the L2 distance may be computed as the following formula:

$${L}_{2} ( {S}_{1} , {S}_{2} ) = \frac{1}{\vert {S}_{1} \vert} {\sum }_{x ∈ {S}_{1}} {\sum }_{y ∈ {S}_{2}} ave {‖ x - y ‖}_{2}$$

where S₁ and S₂ are the sets of two point clouds. x and y are the attributes of the points in S₁ and S₂, respectively.
5) It's proposed to utilize the geometry and attribute information to refine the geometry information of the upsampled point cloud.
   a. In one example, the sparse-tensor based generative convolution may be used to implement point cloud refine module.
   b. In one example, the attribute information of upsampled point cloud may be combined with the upsampled geometry feature to refine the high-resolution point cloud.
      i. In one example, the attribute information can be the color information of the point cloud.
      ii. In one example, the attribute information can be the normal information of the point cloud.
      iii. In one example, the attribute information can be the reflectance information of the point cloud.
   c. In one example, the residuals between the refined point cloud and original point clouds may be learned using supervised learning.
      i. In one example, the error between the constructed points and the true points may be used to update the neural network.
      ii. In one example, the chamfer distance may be used as the loss function for residual learning.
         1. In one example, the chamfer distance may be computed as the following formula:

$${L}_{CD} ( {S}_{1} , {S}_{2} ) = \frac{1}{\vert {S}_{1} \vert} {\sum }_{x ∈ {S}_{1}} min {‖ x - y ‖}_{2} + \frac{1}{\vert {S}_{2} \vert} {\sum }_{x ∈ {S}_{2}} min {‖ x - y ‖}_{2}$$

where S₁ and S_{z} are the sets of two point clouds. x and y are the coordinates of the points in S₁ and S₂, respectively.
2. Alternatively, the chamfer distance can also be computed as the following formula:

$${L}_{CD} ( p , \hat{p} ) = {\sum }_{x ∈ p} {min}_{\hat{x} ∈ \hat{p}} \backslash \backslash x - \hat{x} {\backslash \backslash}_{2}^{2} + {\sum }_{\hat{x} ∈ p} {min}_{x ∈ \hat{p}} \backslash \backslash x - \hat{x} {\backslash \backslash}_{2}^{2}$$

where the p represents the original point cloud and the \hat{p} represents the reconstructed point cloud. The x and \hat{x} are any point in point cloud p and \hat{p}.
6) It's proposed to combine the above methods with the existing point cloud codecs to improve encoding and decoding performance.
   a. In one example, the data characteristics of different codecs may be analyzed.
   b. In one example, the training sets for specific codecs may be designed and produced.
      i. In one example, the input and output of G-PCC (encoder and decoder) may be used as a training set.
      ii. In one example, the input and output of V-PCC (encoder and decoder) may be used as a training set.
      iii. In one example, the input and output of Draco (encoder and decoder) may be used as a training set.
   c. In one example, the pre-trained super-resolution network may be finetuned on a specific coding datasets.
   d. In one example, the super-resolution network may be designed as a plug in universal post-processing network for lossy point cloud compression.
7) The above solutions are proposed to deal with the super-solution of large scale point clouds.
   a. In one example, the large scale point clouds can be the synthetic mesh-based point clouds, such as ShapeNet, ModelNet.
   b. In one example, the large scale point clouds can be the real-world point cloud, such as indoor LiDAR scanned objects, outdoor dynamically acquired LiDAR-based point clouds and photo-realistic digital human point clouds.
8) Whether to and/or how to apply a method disclosed above may be signaled from encoder to decoder in a bitstream/frame/tile/slice/octree/etc.
9) Whether to and/or how to apply the disclosed methods above may be dependent on coded information, such as dimensions, colour format, colour component, slice/picture type.

### General Aspects

10) A syntax element disclosed above may be binarized as a flag, a fixed length code, an EG(x) code, a unary code, a truncated unary code, a truncated binary code, etc. It can be signed or unsigned.
11) A syntax element disclosed above may be coded with at least one context model. Or it may be bypass coded.
12) A syntax element disclosed above may be signaled in a conditional way.
   a. The SE is signaled only if the corresponding function is applicable.
   b. The SE is signaled only if the dimensions (width and/or height) of the block satisfy a condition.
13) A syntax element disclosed above may be signaled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
14) Whether to and/or how to apply the disclosed methods above may be signalled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
15) Whether to and/or how to apply the disclosed methods above may be dependent on coded information, such as block size, colour format, single/dual tree partitioning, colour component, slice/picture type.
16) The proposed methods disclosed in this document may be used in other coding tools which require chroma fusion.

### 6. Embodiments

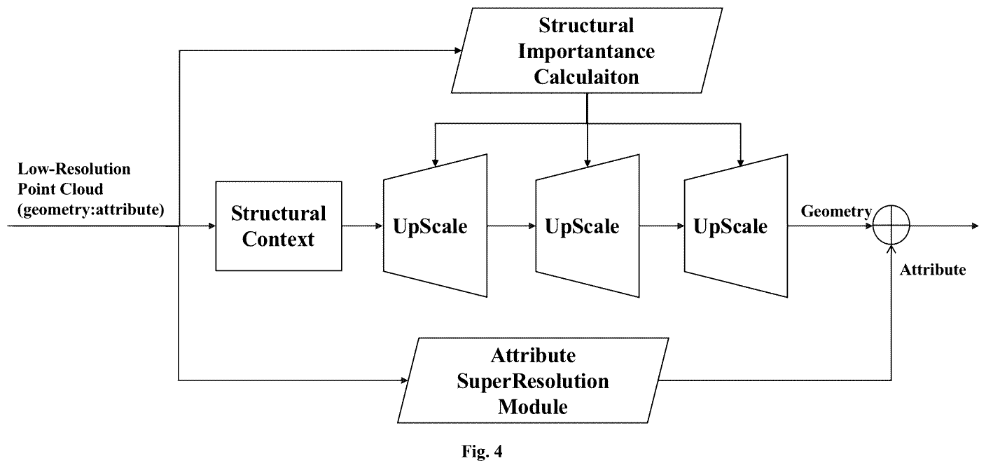

A joint super-resolution of point cloud geometry and attribute method is proposed. An example of the processing flow for the joint super-resolution of point cloud geometry and attribute method is depicted in FIG. 4. Firstly, the sparse tensor based convolution network is used to build the initial geometry structure features of the low resolution point cloud. In this way, low resolution point cloud data is characterized with a high-dimensional feature information for further processing. Secondly, the high-resolution point clouds geometry information are generated using progressive upsampling to reduce the construction difficulty, and the construction results are constrained using BCE losses at each stage, where the losses are more biased towards regions with more complex structures. Thus, the BCE loss constraint could make the construction better for the more complex regions. Thirdly, recolouring algorithm is used to compute the attribute information of the upsampled high-resolution point clouds. Finally, the geometry and attribute information is utilized to refine the upsampled point cloud with sparse-tensor based MLP convolution network.

More details of the embodiments of the present disclosure will be described below which are related to point cloud super-resolution. The embodiments of the present disclosure should be considered as examples to explain the general concepts and should not be interpreted in a narrow way. Furthermore, these embodiments can be applied individually or combined in any manner.

As used herein, the term “point cloud sequence” may refer to a sequence of one or more point clouds. The term “point cloud frame” or “frame” may refer to a point cloud in a point cloud sequence. The term “point cloud (PC) sample” may refer to a frame, a sub-region within a frame, a picture, a slice, a sub-frame, a sub-picture, a tile, a segment, or any other suitable processing unit.

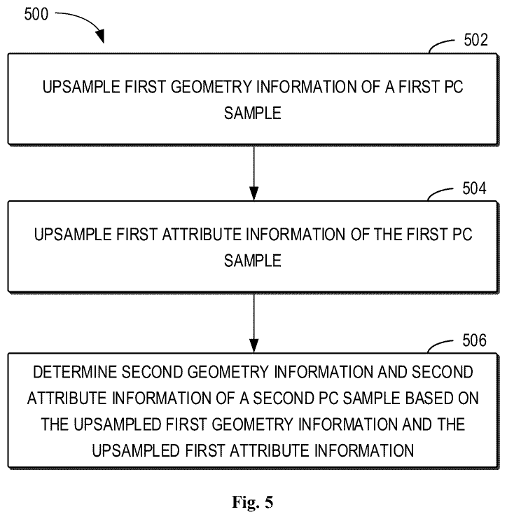

FIG. 5 illustrates a flowchart of a method 500 for point cloud processing in accordance with some embodiments of the present disclosure. At 502, first geometry information of a first PC sample is upsampled. In some embodiments, a geometry structure feature of the first PC sample may be generated based on the first geometry information, and a upsampling process may be applied on the geometry structure feature, so as to obtain the upsampled first geometry information. This will be described in detail below.

At 504, first attribute information of the first PC sample is upsampled. By way of example, the first attribute information may be upsampled based on a recoloring algorithm. This will be described in detail below. It should be understood that the first geometry information and/or the first attribute information may also be upsampled in any other suitable manner, such as any of the upsampling schemes described in above section 3. The scope of the present disclosure is not limited in this respect.

At 506, second geometry information and second attribute information of a second PC sample is determined based on the upsampled first geometry information and the upsampled first attribute information. The second PC sample corresponds to the first PC sample, and a resolution of the second PC sample is higher than a resolution of the first PC sample. For example, the second PC sample may be of a higher point density than the first PC sample and may be regard as a result of performing super-resolution on the first PC sample.

In some embodiment, the upsampled first geometry information may be determined to be the second geometry information of the second PC sample. Additionally or alternatively, the upsampled first attribute information may be determined to be the second attribute information of a second PC sample. In some further embodiment, the upsampled first geometry information and/or the upsampled first attribute information may be further refined. This will be described in detail below.

In view of the above, both the geometry information and the attribute information of a point cloud are upsampled. Compared with the conventional solution where only one of the geometry information and the attribute information is upsampled, the proposed method can advantageously support joint super-resolution of geometry information and attribute information of the point cloud. Thereby, the performance of point cloud super-resolution can be improved.

The upsampling of the first geometry information will be described at first. In some embodiments, the geometry structure feature of the first PC sample may be determined by using a convolution operation, a complex variable-point expansion operation and/or the like. For example, the complex variable-point expansion operation may comprise a symmetric structure of at least one downsampling operation and at least one up-sampling operation. In one example, an input of the complex variable-point expansion operation may be downsampled with the at least one downsampling operation, and then a result of the downsampling may be upsampled with the at least one up-sampling operation.

By way of example, the at least one downsampling operation may be implemented with a sparse tensor based convolution network. Additionally or alternatively, the at least one downsampling operation may comprise a plurality of downsampling operations that are performed iteratively. For example, two consecutive downsampling operations may be used. It should be understood that the specific values recited herein are intended to be exemplary rather than limiting the scope of the present disclosure.

Moreover, the at least one upsampling operation may be implemented with a lossless sparse deconvolution. Additionally or alternatively, the at least one upsampling operation may comprise a plurality of upsampling operations that are performed iteratively. For example, three consecutive upsampling operations may be used.

In some embodiments, information regarding how to generate the geometry structure feature may be indicated by a first indication. In one example, the first indication may be predetermined. Alternatively, the first indication may be comprised in a bitstream for the first PC sample. In another example, the first indication may be set adaptively. In a further example, the first indication may be determined based on an upsampling rate or the like.

In some embodiments, the upsampling process applied on the geometry structure feature may comprise a single upsampling operation, which corresponds to a one-stage upsampling. Alternatively, the upsampling process may comprise a plurality of upsampling operations that are performed iteratively, which corresponds to multi-stage progressive upsampling. By way of example, the number of the plurality of upsampling operations may be equal to a predetermined number, such as 2, 3 or the like. Additionally or alternatively, the number of the plurality of upsampling operations may be indicated by a second indication. In one example, the second indication may be predetermined. Alternatively, the second indication may be comprised in a bitstream for the first PC sample. In another example, the second indication may be set adaptively. In a further example, the second indication may be determined based on an upsampling rate or the like.

In some embodiments, the upsampling process may be implemented with a sparse tensor based generative convolution.

In some embodiments, a first machine learning based (ML-based) model may be used for applying the upsampling process on the geometry structure feature. For example, the first ML-based model may comprise a neural network. As used herein, the term “model” is referred to as an association between an input and an output learned from training data, and thus a corresponding output may be generated for a given input after the training. The generation of the model may be based on a machine learning technique. In general, a machine learning model may be built, which receives input information and makes predictions based on the input information. For example, a classification model may predict a class of the input information among a predetermined set of classes. As used herein, “model” may also be referred to as “machine learning model”, “learning model”, “machine learning network”, or “learning network,” which are used interchangeably herein.

During a training process of the first ML-based, an original PC sample may be downsampled to obtain a downsampled PC sample, and the first ML-based model may be used to applying the upsampling process on a geometry structure feature of the downsampled PC sample. In addition, parameters of the first ML-based model may be updated based on a loss function. During the training process, the geometry information of original PC sample may be used as ground truth.

In some embodiments, the loss function may be a one stage loss function. In this case, a single loss function is determined for the upsampling process, regardless of whether the upsampling process is implemented as single stage or multi-sage. Alternatively, the loss function may be a multi-stage progressive loss function. For example, there is a loss function for each stage of a multi-stage upsampling process.

In some embodiments, a binary cross entropy (BCE) value may be used as a loss function for each stage.

In some embodiments, a loss function for each stage may be determined based on a part of points of the original PC sample. Alternatively, a loss function for a stage other than the last stage may be determined based on a part of points of the original PC sample. By way of example, a priority of a point of the original PC sample may be determined based on an importance of the point. For example, points of the original PC sample may be of different priorities, and the part of points may be of priorities higher than the rest part of the original PC sample.

In some embodiments, a range of the part of points used for determining a loss function for a stage may be indicated by a third indication. In one example, the third indication may be predetermined. Alternatively, the third indication may be comprised in a bitstream for the first PC sample. In another example, the third indication may be set adaptively. In a further example, the third indication may be determined based on an upsampling rate or the like.

In some embodiments, points of the original PC sample may be sorted in a descending order based on importance of the points. The loss function may be a 3-stage loss function. For example, a loss function for the first stage may be determined based on the top K % points of the original PC sample, a loss function for the second stage may be determined based on the top M % points of the original PC sample, and a loss function for the last stage may be determined based on the top N % points of the original PC sample. Each of K, M and N may be a positive number. For example, K may be smaller than M, and M may be smaller than N. By way of example rather than limitation, K may be equal to 30, M may be equal to 60, and N may be equal to 100. Additionally, K, M and N may be indicated in the bitstream as three indications indicating a range of the part of points used for determining a loss function.

In some embodiments, at 504, the first attribute information may be upsampled based on a recoloring algorithm. For example, the first attribute information may be upsampled based on the upsampled first geometry information.

In some embodiments, at least one nearest neighbour for a first point in the upsampled first geometry information may be selected from points in the first PC sample. For example, a distance between the first point and a point in the first PC sample may be determined based on a Euclidean distance. In addition, the at least one nearest neighbour may be selected based on a Euclidean distance. In some further embodiments, the at least one nearest neighbour may be selected based on a K Nearest Neighbors (KNN) algorithm.

In some embodiments, attribute information of the first point may be determined by weighting attribute information of the at least one nearest neighbour based on a distance between the first point and the at least one nearest neighbour. For example, in case that the at least one nearest neighbour comprises a plurality of nearest neighbours, the attribute information of the first point may be determined to be a weighted average of attribute information of the plurality of nearest neighbours.

In some embodiments, at 506, the second attribute information of the second PC sample may be obtained by refining the upsampled first attribute information with a second ML-based model. For example, the second ML-based model may comprise a neural network. In one example, the neural network may be associated with a U-Net structural network, such as a U-Net network based on sparse convolution operations or the like. In another example, the neural network may be associated with a multilayer perceptron (MLP) structural network. For example, an MLP operation may be implemented with sparse tensor based convolution network.

In some embodiments, during a training process of the second ML-based model, an original PC sample may be downsampled to obtain a downsampled PC sample, and the second ML-based model may be used to refine upsampled attribute information of the downsampled PC sample. In addition, parameters of the second ML-based model may be updated based on a difference between the refined upsampled attribute information of the downsampled PC sample and attribute information of the original PC sample.

In some embodiments, the parameters of the second ML-based model may be updated based on supervised learning. By way of example, a loss function for updating the parameters of the second ML-based model may be determined based on an L2 distance between the refined upsampled attribute information of the downsampled PC sample and attribute information of the original PC sample.

In some embodiments, the L2 distance may be determined as follows:

$${L}_{2} ( {S}_{1} , {S}_{2} ) = \frac{1}{\vert {S}_{1} \vert} {\sum }_{x ∈ {S}_{1}} {\sum }_{y ∈ {S}_{2}} ave ( {‖ x - y ‖}_{2} )$$

where L₂(S₁,S₂) represents the L2 distance between the refined upsampled attribute information of the downsampled PC sample and attribute information of the original PC sample, x represents an attribute of a point in the refined upsampled attribute information, y represents an attribute of a point in the original PC sample, ∥ ∥₂ represents the Euclidean norm, ave( ) represents average function, S₁ represents a set of points in the refined upsampled attribute information, S₂ represents a set of points in the original PC sample, and |S₁| represents the number of points in the set of points represented by S₁.

In some embodiments, at 506, the second geometry information may be obtained by refining the upsampled first geometry information with a third ML-based model. For example, the third ML-based model may be implemented with a sparse-tensor based generative convolution.

In some embodiments, the upsampled first geometry information may be refined based on the upsampled first attribute information. For example, the upsampled first attribute information may comprise color information, normal information, reflectance information, and/or the like.

In some embodiments, during a training process of the second ML-based model, an original PC sample may be downsampled to obtain a downsampled PC sample, and the third ML-based model may be used to refine upsampled geometry information of the downsampled PC sample. In addition, parameters of the third ML-based model may be updated based on supervised learning.

In some embodiments, the parameters of the third ML-based model may be updated based on a difference between the refined upsampled geometry information of the downsampled PC sample and geometry information of the original PC sample. For example, a loss function for updating the parameters of the third ML-based model may be determined based on a chamfer distance between the refined upsampled geometry information of the downsampled PC sample and geometry information of the original PC sample.

In some embodiments, the chamfer distance may be determined as follows:

$${L}_{CD} ( {S}_{1} , {S}_{2} ) = \frac{1}{\vert {S}_{1} \vert} {\sum }_{x ∈ {S}_{1}} min {‖ x - y ‖}_{2} + \frac{1}{\vert {S}_{2} \vert} {\sum }_{x ∈ {S}_{2}} min {‖ x - y ‖}_{2}$$

where L_{CD}(S₁,S₂) represents the chamfer distance between the refined upsampled geometry information of the downsampled PC sample and geometry information of the original PC sample, x represents coordinates of a point in the refined upsampled geometry information, y represents coordinates of a point in the original PC sample, ∥ ∥₂ represents the Euclidean norm, S₁ represents a set of points in the refined upsampled geometry information, S₂ represents a set of points in the original PC sample, |S₁| represents the number of points in the set of points represented by S₁, and |S₂| represents the number of points in the set of points represented by S₂.

In some alternative embodiments, the chamfer distance may be determined as follows:

$${L}_{CD} ( p , \hat{p} ) = {\sum }_{x ∈ p} {min}_{\hat{x} ∈ \hat{p}} \backslash \backslash x - \hat{x} {\backslash \backslash}_{2}^{2} + {\sum }_{\hat{x} ∈ p} {min}_{x ∈ \hat{p}} \backslash \backslash x - \hat{x} {\backslash \backslash}_{2}^{2}$$

where L_{CD} (p, \hat{p}) represents the chamfer distance between the refined upsampled geometry information of the downsampled PC sample and geometry information of the original PC sample, x represents coordinates of a point in the refined upsampled geometry information, x represents coordinates of a point in the original PC sample, ∥ ∥₂ represents the Euclidean norm, po represents a set of points in the refined upsampled geometry information, and p represents a set of points in the original PC sample.

In some embodiments, the method may be implemented in combination with a point cloud codec. For example, data characteristics of the point cloud coded may be analyzed. Additionally or alternatively, a training set for the point cloud codec may be designed and produced. In one example embodiment, a point cloud decoded from the bitstream may be processed based on the proposed method so as to upsample the reconstructed point cloud. In another example embodiment, the proposed method may be applied in combination with a downsampling process. By way of example, an original point cloud may be downsampled at the encoder side and the downsampled point cloud may be encoded into the bitstream. At the decoder side, the downsampled point cloud may be decoded from the bitstream and upsampled based on the proposed method so as to reconstruct the original point cloud. It should be understood that the above illustrations are described merely for purpose of description. The scope of the present disclosure is not limited in this respect.

In some embodiments, at least one of the following may be used as the training set: input and output of Geometry-based Point Cloud Compression (G-PCC), input and output of Video-based Point Cloud Compression (V-PCC), or input and output of Draco.

In some embodiments, a pre-trained super-resolution network for implementing the method may be finetuned based on a coding dataset. In addition, the pre-trained super-resolution network may be used as a plug in universal post-processing network for lossy point cloud compression.

In some embodiments, the first PC sample may be a large-scale point cloud. For example, the large-scale point cloud may be a synthetic mesh-based point cloud, a real-world point cloud, or the like.

In some embodiments, information regarding whether to and/or how to apply the method may be indicated in a bitstream. Additionally, the information regarding whether to and/or how to apply the method may be indicated in one of the following: a frame, a tile, a slice, or an octree.

In some embodiments, information regarding whether to and/or how to apply the method may be dependent on coded information. By way of example, the coded information may comprise a dimension, a color format, a color component, a slice type, a picture type, and/or the like.

In view of the above, the solutions in accordance with some embodiments of the present disclosure can advantageously improve performance of point cloud super-resolution.

Implementations of the present disclosure can be described in view of the following clauses, the features of which can be combined in any reasonable manner.

Clause 1. A method for point cloud processing, comprising: upsampling first geometry information of a first point cloud (PC) sample; upsampling first attribute information of the first PC sample; and determining second geometry information and second attribute information of a second PC sample based on the upsampled first geometry information and the upsampled first attribute information, wherein the second PC sample corresponds to the first PC sample, and a resolution of the second PC sample is higher than a resolution of the first PC sample.

Clause 2. The method of clause 1, wherein upsampling the first geometry information comprises: generating a geometry structure feature of the first PC sample based on the first geometry information; and applying a upsampling process on the geometry structure feature.

Clause 3. The method of clause 2, wherein the geometry structure feature is determined by using at least one of the following: a convolution operation, or a complex variable-point expansion operation.

Clause 4. The method of clause 3, wherein the complex variable-point expansion operation comprises a symmetric structure of at least one downsampling operation and at least one up-sampling operation.

Clause 5. The method of clause 4, wherein the at least one downsampling operation is implemented with a sparse tensor based convolution network.

Clause 6. The method of any of clauses 4-5, wherein the at least one downsampling operation comprises a plurality of downsampling operations that are performed iteratively.

Clause 7. The method of any of clauses 4-6, wherein the at least one upsampling operation is implemented with a lossless sparse deconvolution.

Clause 8. The method of any of clauses 4-7, wherein the at least one upsampling operation comprises a plurality of upsampling operations that are performed iteratively.

Clause 9. The method of any of clauses 2-8, wherein information regarding how to generate the geometry structure feature is indicated by a first indication.

Clause 10. The method of clause 9, wherein the first indication is predetermined, or the first indication is comprised in a bitstream for the first PC sample, or the first indication is set adaptively, or the first indication is determined based on an upsampling rate.

Clause 11. The method of any of clauses 2-10, wherein the upsampling process comprises a single upsampling operation.

Clause 12. The method of any of clauses 2-10, wherein the upsampling process comprises a plurality of upsampling operations that are performed iteratively.

Clause 13. The method of clause 12, wherein the number of the plurality of upsampling operations is equal to a predetermined number.

Clause 14. The method of any of clauses 12-13, wherein the number of the plurality of upsampling operations is indicated by a second indication.

Clause 15. The method of clause 14, wherein the second indication is predetermined, or the second indication is comprised in a bitstream for the first PC sample, or the second indication is set adaptively, or the second indication is determined based on an upsampling rate.

Clause 16. The method of any of clauses 2-15, wherein the upsampling process is implemented with a sparse tensor based generative convolution.

Clause 17. The method of any of clauses 2-16, wherein during a training process of a first machine learning based (ML-based) model for applying the upsampling process, an original PC sample is downsampled to obtain a downsampled PC sample, the first ML-based model is used to applying the upsampling process on a geometry structure feature of the downsampled PC sample, and parameters of the first ML-based model are updated based on a loss function.

Clause 18. The method of clause 17, wherein the first ML-based model comprises a neural network.

Clause 19. The method of any of clauses 17-18, wherein the loss function is a multi-stage progressive loss function or a one stage loss function.

Clause 20. The method of clause 19, wherein a binary cross entropy (BCE) value is used as a loss function for each stage.

Clause 21. The method of any of clauses 19-20, wherein a loss function for each stage is determined based on a part of points of the original PC sample, or a loss function for a stage other than the last stage is determined based on a part of points of the original PC sample.

Clause 22. The method of clause 21, wherein points of the original PC sample are of different priorities, and the part of points are of priorities higher than the rest part of the original PC sample.

Clause 23. The method of clause 22, wherein a priority of a point of the original PC sample is determined based on an importance of the point.

Clause 24. The method of any of clauses 21-23, wherein a range of the part of points used for determining a loss function for a stage is indicated by a third indication.

Clause 25. The method of clause 24, wherein the third indication is predetermined, or the third indication is comprised in a bitstream for the first PC sample, or the third indication is set adaptively, or the third indication is determined based on an upsampling rate.

Clause 26. The method of any of clauses 21-25, wherein points of the original PC sample are sorted in a descending order based on importance of the points, the loss function is a 3-stage loss function, a loss function for the first stage is determined based on the top K % points of the original PC sample, a loss function for the second stage is determined based on the top M % points of the original PC sample, a loss function for the last stage is determined based on the top N % points of the original PC sample, and each of K, M and N is a positive number.

Clause 27. The method of clause 26, wherein K is smaller than M, and M is smaller than N.

Clause 28. The method of any of clauses 1-27, wherein the first attribute information is upsampled based on a recoloring algorithm.

Clause 29. The method of any of clauses 1-28, wherein the first attribute information is upsampled based on the upsampled first geometry information.

Clause 30. The method of clause 29, wherein at least one nearest neighbour for a first point in the upsampled first geometry information is selected from points in the first PC sample.

Clause 31. The method of clause 30, wherein a distance between the first point and a point in the first PC sample is determined based on a Euclidean distance.

Clause 32. The method of any of clauses 30-31, wherein the at least one nearest neighbour is selected based on a Euclidean distance.

Clause 33. The method of any of clauses 30-32, wherein the at least one nearest neighbour is selected based on a K Nearest Neighbors (KNN) algorithm.

Clause 34. The method of any of clauses 30-33, wherein attribute information of the first point is determined by weighting attribute information of the at least one nearest neighbour based on a distance between the first point and the at least one nearest neighbour.

Clause 35. The method of any of clauses 1-34, wherein determining the second geometry information and the second attribute information comprises: obtaining the second attribute information by refining the upsampled first attribute information with a second ML-based model.

Clause 36. The method of clause 35, wherein during a training process of the second ML-based model, an original PC sample is downsampled to obtain a downsampled PC sample, the second ML-based model is used to refine upsampled attribute information of the downsampled PC sample, and parameters of the second ML-based model are updated based on a difference between the refined upsampled attribute information of the downsampled PC sample and attribute information of the original PC sample.

Clause 37. The method of any of clauses 35-36, wherein the second ML-based model comprises a neural network.

Clause 38. The method of clause 37, wherein the neural network is associated with a U-Net structural network.

Clause 39. The method of clause 37, wherein the neural network is a U-Net network based on sparse convolution operations.

Clause 40. The method of clause 37, wherein the neural network is associated with a multilayer perceptron (MLP) structural network.

Clause 41. The method of clause 37, wherein an MLP operation is implemented with sparse tensor based convolution network.

Clause 42. The method of any of clauses 36-41, wherein the parameters of the second ML-based model are updated based on supervised learning.

Clause 43. The method of any of clauses 36-42, wherein a loss function for updating the parameters of the second ML-based model is determined based on an L2 distance between the refined upsampled attribute information of the downsampled PC sample and attribute information of the original PC sample.

Clause 44. The method of clause 43, wherein the L2 distance is determined as follows:

$${L}_{2} ( {S}_{1} , {S}_{2} ) = \frac{1}{\vert {S}_{1} \vert} {\sum }_{x ∈ {S}_{1}} {\sum }_{y ∈ {S}_{2}} ave ( {‖ x - y ‖}_{2} )$$

where L2(S₁,S₂) represents the L2 distance between the refined upsampled attribute information of the downsampled PC sample and attribute information of the original PC sample, x represents an attribute of a point in the refined upsampled attribute information, y represents an attribute of a point in the original PC sample, ∥ ∥₂ represents the Euclidean norm, ave( ) represents average function, S₁ represents a set of points in the refined upsampled attribute information, S₂ represents a set of points in the original PC sample, and |S₁| represents the number of points in the set of points represented by S₁.

Clause 45. The method of any of clauses 1-44, wherein determining the second geometry information and the second attribute information comprises: obtaining the second geometry information by refining the upsampled first geometry information with a third ML-based model.

Clause 46. The method of clause 45, wherein the third ML-based model is implemented with a sparse-tensor based generative convolution.

Clause 47. The method of any of clauses 45-46, wherein the upsampled first geometry information is refined based on the upsampled first attribute information.

Clause 48. The method of clause 47, wherein the upsampled first attribute information comprises at least one of the following: color information, normal information, or reflectance information.

Clause 49. The method of any of clauses 45-48, wherein during a training process of the second ML-based model, an original PC sample is downsampled to obtain a downsampled PC sample, the third ML-based model is used to refine upsampled geometry information of the downsampled PC sample, and parameters of the third ML-based model are updated based on supervised learning.

Clause 50. The method of clause 49, wherein the parameters of the third ML-based model are updated based on a difference between the refined upsampled geometry information of the downsampled PC sample and geometry information of the original PC sample.

Clause 51. The method of any of clauses 49-50, wherein a loss function for updating the parameters of the third ML-based model is determined based on a chamfer distance between the refined upsampled geometry information of the downsampled PC sample and geometry information of the original PC sample.

Clause 52. The method of clause 51, wherein the chamfer distance is determined as follows:

$${L}_{CD} ( {S}_{1} , {S}_{2} ) = \frac{1}{\vert {S}_{1} \vert} {\sum }_{x ∈ {S}_{1}} min {‖ x - y ‖}_{2} + \frac{1}{\vert {S}_{2} \vert} {\sum }_{x ∈ {S}_{2}} min {‖ x - y ‖}_{2}$$

where L_{CD}(S₁,S₂) represents the chamfer distance between the refined upsampled geometry information of the downsampled PC sample and geometry information of the original PC sample, x represents coordinates of a point in the refined upsampled geometry information, y represents coordinates of a point in the original PC sample, ∥ ∥₂ represents the Euclidean norm, S₁ represents a set of points in the refined upsampled geometry information, S₂ represents a set of points in the original PC sample, |S₁| represents the number of points in the set of points represented by S₁, and |S₂| represents the number of points in the set of points represented by S₂.

Clause 53. The method of clause 51, wherein the chamfer distance is determined as follows:

$${L}_{CD} ( p , \hat{p} ) = {\sum }_{x ∈ p} {min}_{\hat{x} ∈ \hat{p}} \backslash \backslash x - \hat{x} {\backslash \backslash}_{2}^{2} + {\sum }_{\hat{x} ∈ p} {min}_{x ∈ \hat{p}} \backslash \backslash x - \hat{x} {\backslash \backslash}_{2}^{2}$$

where L_{CD}(p, \hat{p}) represents the chamfer distance between the refined upsampled geometry information of the downsampled PC sample and geometry information of the original PC sample, \hat{x} represents coordinates of a point in the refined upsampled geometry information, x represents coordinates of a point in the original PC sample, ∥ ∥₂ represents the Euclidean norm, \hat{p} represents a set of points in the refined upsampled geometry information, and p represents a set of points in the original PC sample.

Clause 54. The method of any of clauses 1-53, wherein the method is implemented in combination with a point cloud codec.

Clause 55. The method of clause 54, wherein data characteristics of the point cloud coded is analyzed.

Clause 56. The method of any of clauses 54-55, wherein a training set for the point cloud codec is designed and produced.

Clause 57. The method of clause 56, wherein at least one of the following is used as the training set: input and output of Geometry-based Point Cloud Compression (G-PCC), input and output of Video-based Point Cloud Compression (V-PCC), or input and output of Draco.

Clause 58. The method of any of clauses 1-57, wherein a pre-trained super-resolution network for implementing the method is finetuned based on a coding dataset.

Clause 59. The method of clause 58, wherein the pre-trained super-resolution network is used as a plug in universal post-processing network for lossy point cloud compression.

Clause 60. The method of any of clauses 1-59, wherein the first PC sample is a large-scale point cloud.

Clause 61. The method of clause 60, wherein the large-scale point cloud is a synthetic mesh-based point cloud or a real-world point cloud.

Clause 62. The method of any of clauses 1-61, wherein a PC sample is one of the following: a frame of a point cloud sequence, a picture of a point cloud sequence, a slice of a point cloud sequence, a sub-frame of a point cloud sequence, a sub-picture of a point cloud sequence, a tile of a point cloud sequence, or a segment of a point cloud sequence.

Clause 63. The method of any of clauses 1-62, wherein information regarding whether to and/or how to apply the method is indicated in a bitstream.

Clause 64. The method of any of clauses 1-62, wherein information regarding whether to and/or how to apply the method is indicated in one of the following: a frame, a tile, a slice, or an octree.

Clause 65. The method of any of clauses 1-64, wherein information regarding whether to and/or how to apply the method is dependent on coded information.

Clause 66. The method of clause 65, wherein the coded information comprises at least one of the following: a dimension, a color format, a color component, a slice type, or a picture type.

Clause 67. An apparatus for point cloud processing comprising a processor and a non-transitory memory with instructions thereon, wherein the instructions upon execution by the processor, cause the processor to perform a method in accordance with any of clauses 1-66.

Clause 68. A non-transitory computer-readable storage medium storing instructions that cause a processor to perform a method in accordance with any of clauses 1-66.

### Example Device

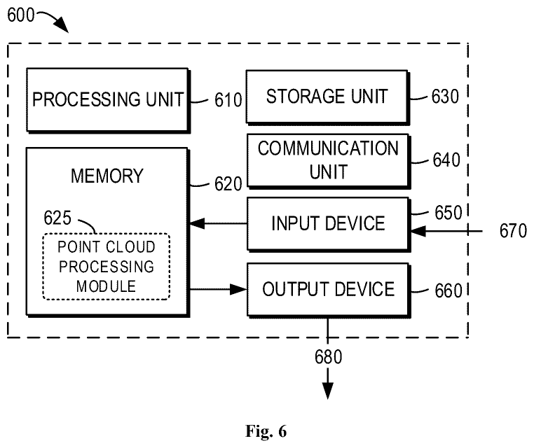

FIG. 6 illustrates a block diagram of a computing device 600 in which various embodiments of the present disclosure can be implemented. The computing device 600 may be implemented as or included in the source device 110 (or the GPCC encoder 116 or 200) or the destination device 120 (or the GPCC decoder 126 or 300).

It would be appreciated that the computing device 600 shown in FIG. 6 is merely for purpose of illustration, without suggesting any limitation to the functions and scopes of the embodiments of the present disclosure in any manner.

As shown in FIG. 6, the computing device 600 includes a general-purpose computing device 600. The computing device 600 may at least comprise one or more processors or processing units 610, a memory 620, a storage unit 630, one or more communication units 640, one or more input devices 650, and one or more output devices 660.

In some embodiments, the computing device 600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 600 can support any type of interface to a user (such as “wearable” circuitry and the like).

The processing unit 610 may be a physical or virtual processor and can implement various processes based on programs stored in the memory 620. In a multi-processor system, multiple processing units execute computer executable instructions in parallel so as to improve the parallel processing capability of the computing device 600. The processing unit 610 may also be referred to as a central processing unit (CPU), a microprocessor, a controller or a microcontroller.

The computing device 600 typically includes various computer storage medium. Such medium can be any medium accessible by the computing device 600, including, but not limited to, volatile and non-volatile medium, or detachable and non-detachable medium. The memory 620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 630 may be any detachable or non-detachable medium and may include a machine-readable medium such as a memory, flash memory drive, magnetic disk or another other media, which can be used for storing information and/or data and can be accessed in the computing device 600.

The computing device 600 may further include additional detachable/non-detachable, volatile/non-volatile memory medium. Although not shown in FIG. 6, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 640 communicates with a further computing device via the communication medium. In addition, the functions of the components in the computing device 600 can be implemented by a single computing cluster or multiple computing machines that can communicate via communication connections. Therefore, the computing device 600 can operate in a networked environment using a logical connection with one or more other servers, networked personal computers (PCs) or further general network nodes.

The input device 650 may be one or more of a variety of input devices, such as a mouse, keyboard, tracking ball, voice-input device, and the like. The output device 660 may be one or more of a variety of output devices, such as a display, loudspeaker, printer, and the like. By means of the communication unit 640, the computing device 600 can further communicate with one or more external devices (not shown) such as the storage devices and display device, with one or more devices enabling the user to interact with the computing device 600, or any devices (such as a network card, a modem and the like) enabling the computing device 600 to communicate with one or more other computing devices, if required. Such communication can be performed via input/output (I/O) interfaces (not shown).

In some embodiments, instead of being integrated in a single device, some or all components of the computing device 600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 600 may be used to implement point cloud encoding/decoding in embodiments of the present disclosure. The memory 620 may include one or more point cloud processing modules 625 having one or more program instructions. These modules are accessible and executable by the processing unit 610 to perform the functionalities of the various embodiments described herein.

In the example embodiments of performing point cloud encoding, the input device 650 may receive point cloud data as an input 670 to be encoded. The point cloud data may be processed, for example, by the point cloud processing module 625, to generate an encoded bitstream. The encoded bitstream may be provided via the output device 660 as an output 680.

In the example embodiments of performing point cloud decoding, the input device 650 may receive an encoded bitstream as the input 670. The encoded bitstream may be processed, for example, by the point cloud processing module 625, to generate decoded point cloud data. The decoded point cloud data may be provided via the output device 660 as the output 680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud processing, comprising:
upsampling first geometry information of a first point cloud (PC) sample;
upsampling first attribute information of the first PC sample; and
determining second geometry information and second attribute information of a second PC sample based on the upsampled first geometry information and the upsampled first attribute information, wherein the second PC sample corresponds to the first PC sample, and a resolution of the second PC sample is higher than a resolution of the first PC sample.

2. The method of claim 1, wherein upsampling the first geometry information comprises:
generating a geometry structure feature of the first PC sample based on the first geometry information; and
applying a upsampling process on the geometry structure feature.

3. The method of claim 2, wherein the geometry structure feature is determined by using at least one of the following:
a convolution operation, or
a complex variable-point expansion operation.

4. The method of claim 3, wherein the complex variable-point expansion operation comprises a symmetric structure of at least one downsampling operation and at least one up-sampling operation.

5. The method of claim 2, wherein information regarding how to generate the geometry structure feature is indicated by a first indication, or
wherein the upsampling process comprises a single upsampling operation, or
wherein the upsampling process comprises a plurality of upsampling operations that are performed iteratively, or
wherein the upsampling process is implemented with a sparse tensor based generative convolution.

6. The method of claim 2, wherein during a training process of a first machine learning based (ML-based) model for applying the upsampling process, an original PC sample is downsampled to obtain a downsampled PC sample, the first ML-based model is used to applying the upsampling process on a geometry structure feature of the downsampled PC sample, and parameters of the first ML-based model are updated based on a loss function.

7. The method of claim 6, wherein the loss function is a multi-stage progressive loss function or a one stage loss function.

8. The method of claim 7, wherein a loss function for each stage is determined based on a part of points of the original PC sample, or
a loss function for a stage other than the last stage is determined based on a part of points of the original PC sample.

9. The method of claim 8, wherein points of the original PC sample are of different priorities, and the part of points are of priorities higher than the rest part of the original PC sample, or
wherein a range of the part of points used for determining a loss function for a stage is indicated by a third indication, or
wherein points of the original PC sample are sorted in a descending order based on importance of the points, the loss function is a 3-stage loss function, a loss function for the first stage is determined based on the top K % points of the original PC sample, a loss function for the second stage is determined based on the top M % points of the original PC sample, a loss function for the last stage is determined based on the top N % points of the original PC sample, and each of K, M and N is a positive number.

10. The method of claim 1, wherein the first attribute information is upsampled based on a recoloring algorithm, or
wherein the first attribute information is upsampled based on the upsampled first geometry information.

11. The method of claim 10, wherein at least one nearest neighbour for a first point in the upsampled first geometry information is selected from points in the first PC sample.

12. The method of claim 11, wherein a distance between the first point and a point in the first PC sample is determined based on a Euclidean distance, or
wherein the at least one nearest neighbour is selected based on a Euclidean distance, or
wherein the at least one nearest neighbour is selected based on a K Nearest Neighbors (KNN) algorithm, or
wherein attribute information of the first point is determined by weighting attribute information of the at least one nearest neighbour based on a distance between the first point and the at least one nearest neighbour.

13. The method of claim 1, wherein determining the second geometry information and the second attribute information comprises:
obtaining the second attribute information by refining the upsampled first attribute information with a second ML-based model.

14. The method of claim 13, wherein during a training process of the second ML-based model, an original PC sample is downsampled to obtain a downsampled PC sample, the second ML-based model is used to refine upsampled attribute information of the downsampled PC sample, and parameters of the second ML-based model are updated based on a difference between the refined upsampled attribute information of the downsampled PC sample and attribute information of the original PC sample, or
wherein the second ML-based model comprises a neural network.

15. The method of claim 1, wherein determining the second geometry information and the second attribute information comprises:
obtaining the second geometry information by refining the upsampled first geometry information with a third ML-based model.

16. The method of claim 15, wherein the third ML-based model is implemented with a sparse-tensor based generative convolution, or
wherein the upsampled first geometry information is refined based on the upsampled first attribute information, or
wherein during a training process of the second ML-based model, an original PC sample is downsampled to obtain a downsampled PC sample, the third ML-based model is used to refine upsampled geometry information of the downsampled PC sample, and parameters of the third ML-based model are updated based on supervised learning.

17. The method of claim 1, wherein the method is implemented in combination with a point cloud codec, or
wherein a pre-trained super-resolution network for implementing the method is finetuned based on a coding dataset, or
wherein the first PC sample is a large-scale point cloud.

18. The method of claim 1, wherein a PC sample is one of the following:
a frame of a point cloud sequence,
a picture of a point cloud sequence,
a slice of a point cloud sequence,
a sub-frame of a point cloud sequence,
a sub-picture of a point cloud sequence,
a tile of a point cloud sequence, or
a segment of a point cloud sequence.

19. An apparatus for point cloud processing comprising a processor and a non-transitory memory with instructions thereon, wherein the instructions upon execution by the processor, cause the processor to perform acts comprising:
upsampling first geometry information of a first point cloud (PC) sample;
upsampling first attribute information of the first PC sample; and
determining second geometry information and second attribute information of a second PC sample based on the upsampled first geometry information and the upsampled first attribute information, wherein the second PC sample corresponds to the first PC sample, and a resolution of the second PC sample is higher than a resolution of the first PC sample.

20. A non-transitory computer-readable storage medium storing instructions that cause a processor to perform acts comprising:
upsampling first geometry information of a first point cloud (PC) sample;
upsampling first attribute information of the first PC sample; and
determining second geometry information and second attribute information of a second PC sample based on the upsampled first geometry information and the upsampled first attribute information, wherein the second PC sample corresponds to the first PC sample, and a resolution of the second PC sample is higher than a resolution of the first PC sample.
